(19) United States
(12) Patent Application Publication
(10) Pub. No.: US 2013/0346186 A1
(43) Pub. Date: Dec. 26, 2013

(54) METHOD AND SYSTEM FOR ALLOCATING DISPLAY SPACE

(71) Applicants: Jeffrey P. Bezos, Seattle, WA (US); Gus Lopez, Seattle, WA (US); Joel R. Spiegel, Woodinville, WA (US)

(72) Inventors: Jeffrey P. Bezos, Seattle, WA (US); Gus Lopez, Seattle, WA (US); Joel R. Spiegel, Woodinville, WA (US)

(21) Appl. No.: 13/620,372

(22) Filed: Sep. 14, 2012

Related U.S. Application Data
(63) Continuation of application No. 09/437,815, filed on Nov. 10, 1999.

(51) Int. Cl. G06Q 30/02

(52) U.S. Cl. CPC G06Q 30/0277
USPC 705/14.43; 705/14.71; 705/14.73; 705/14.66; 705/14.61

(57) ABSTRACT

Display space on web page may be allocated by bids. In one embodiment, the display space system receives bids indicating a bid amount and an advertisement. When providing a web page with the display space, the display space system selects a bid. The display space system adds the advertisement of the selected bid to the web page. The bid may specify web pages on which the advertisement may be placed, the users to whom the advertisement may be presented, and time when the advertisement may be placed. The bid amount may be in an established currency or in advertising points. Activities for which advertising points may be awarded may include listing an auction, auction bidding, or purchasing of an item. When a user advertisement is placed, the display space system reduces user advertising points. The display space system may also place bids for display space on behalf of the user.

### TECHNICAL FIELD

The described technology relates generally to conducting electronic commerce and, more particularly, to identifying advertisements to be allocated to on-line display space.

### BACKGROUND

Because it facilitates electronic communications between vendors and purchasers, the Internet is increasingly being used to conduct “electronic commerce.” The Internet comprises a vast number of computers and computer networks that are interconnected through communication channels. Electronic commerce refers generally to commercial transactions that are at least partially conducted using the computer systems of the parties to the transactions. For example, a purchaser can use a personal computer to connect via the Internet to a vendor's computer. The purchaser can then interact with the vendor's computer to conduct the transaction.

The Internet facilitates conducting electronic commerce, in part, because it uses standardized techniques for exchanging information. Many standards have been established for exchanging information over the Internet, such as electronic mail, Gopher, and the World Wide Web (“WWW”). The WWW service allows a server computer system (i.e., web server or web site) to send graphical web pages of information to a remote client computer system. The remote client computer system can then display the web pages. Each resource (e.g., computer or web page) of the WWW is uniquely identifiable by a Uniform Resource Locator (“URL”). To view a specific web page, a client computer system specifies the URL for that web page in a request (e.g., a HyperText Transfer Protocol (“HTTP”) request). The request is forwarded to the web server that supports that web page. When that web server receives the request, it sends the requested web page to the client computer system. When the client computer system receives that web page, it typically displays the web page using a browser. A browser is typically a special-purpose application program that effects the requesting of web pages and the displaying of web pages.

Currently, web pages are generally defined using HyperText Markup Language (“HTML”). HTML provides a standard set of tags that define how a web page is to be displayed. When a user indicates to the browser to display a web page, the browser sends a request to the server computer system to transfer to the client computer system an HTML document that defines the web page. When the requested HTML document is received by the client computer system, the browser displays the web page as defined by the HTML document. The HTML document contains various tags that control the displaying of text, graphics, controls, and other features. The HTML document may contain URLs of other web pages available on that server computer system or other server computer systems.

The World Wide Web portion of the Internet is especially conducive to conducting electronic commerce. Many web servers have been developed through which vendors can advertise and sell product and services. The products can include items (e.g., music) that are delivered electronically to the purchaser over the Internet and items (e.g., books) that are delivered through conventional distribution channels (e.g., a common carrier). A server computer system may provide an electronic version of a catalog that lists the items that are available. A user, who is a potential purchaser, may browse through the catalog using a browser and select various items that are to be purchased. When the user has completed selecting the items to be purchased, the server computer system then prompts the user for information to complete the ordering of the items. This purchaser-specific order information may include the purchaser's name, the purchaser's credit card number, and a shipping address for the order. The server computer system then typically confirms the order by sending a confirming web page to the client computer system and schedules shipment of the items.

The World Wide Web is also being used to conduct other types of commercial transactions. For example, server computer systems have been developed to support the conducting of auctions electronically, to support a buying service where a user lists an item that the user wants to purchase and specifies the purchase price, and to support fixed-price sale transactions where users advertise their items to be sold. To conduct an auction electronically, the seller of an item provides a definition of the auction via web pages to a server computer system. The definition includes a description of the item, an auction time period, and optionally a minimum bid. The server computer system then conducts the auction during the specified time period. Potential buyers can search the server computer system for an auction of interest. When such an auction is found, the potential buyer can view the bidding history for the auction and enter a bid for the item. When the auction is closed, the server computer system notifies the winning bidder and the seller (e.g., via electronic mail) so that they can complete the transaction. To purchase an item using a buying service, the user identifies the item (e.g., an airline ticket) and a price that they are willing to pay for the item via a web page to a server computer system. The server computer system contacts potential sellers to see if they are willing to sell the item for that price. If a seller is found, the server computer system notifies the buyer and may automatically charge an account of the buyer.

Because of the vast number of server computer systems that support conducting electronic commerce of one type or another and because of the number of items that are the subject of commercial transactions, it is difficult for a user to locate all the information needed to make a fully informed buy or sell decision. For example, a buyer may want to purchase an item that is being sold or auctioned at several server computer systems. It would be helpful to have a system that would facilitate the dissemination of information needed to make more fully informed buy and sell decisions.

### SUMMARY

A method and system for allocating display space on a web page is provided. In one embodiment, the display space system receives multiple bids each indicating a bid amount and an advertisement. When a request is received to provide a web page that includes the display space, the display space system selects a bid based in part on the bid amount. The display space system then adds the advertisement of the selected bid to the web page. The bid may also include various criteria that specify the web pages on which the advertisement may be placed, the users to whom the advertisement may be presented, and the time when the advertisement may be placed. The bid amount may be a based on an established currency or based on advertising points. The display space system may award advertising points for various activities that users perform. The activities for which advertising points may be awarded may include the listing of an item to be auctioned, the bidding on an item being auctioned, the purchasing of an item at an auction, or the purchasing of an item at a fixed price. The display space system tracks the advertising points that have been allocated to each user. When an advertisement is placed on a web page on behalf of the user, the display space system reduces the number of advertising points allocated to that user. The display space system may also provide an auto bidding mechanism that places bids for display space on behalf of the user. The auto bidding mechanism reviews historical data to identify on which display space to bid and the amount to bid. The auto bidding mechanism may also adjust its bidding strategy based on the access patterns of the users.

### BRIEF DESCRIPTION OF THE DRAWINGS

FIG. 1 illustrates a detailed web page that includes advertisements.

FIG. 2 illustrates a web page that indicates a number of advertising points needed to purchase display space on the detailed web page of FIG. 1.

FIG. 3 illustrates the selecting of a browse category for obtaining advertising point information in a fixed-price model.

FIG. 4 illustrates a web page that includes advertising point information for a browse category.

FIG. 5 illustrates a web page for submitting an advertising plan for purchasing display space using the fixed-price model.

FIG. 6 is a block diagram illustrating the components of the display space system in one embodiment.

FIG. 6A is a block diagram of the components of the display space system in one embodiment.

FIG. 6B is a block diagram illustrating the sub-components of the schedule advertising component.

FIG. 7 is a flow diagram of an example function to schedule advertisements in advance using the fixed-price model.

FIG. 8A illustrates a web page for submitting an advertising plan in one embodiment.

FIG. 8B illustrates an advertisement plan table within the advertising plan database.

FIG. 9 is a flow diagram of an example implementation of the resolve bids function of the display space component.

FIG. 10 is a flow diagram of an example implementation of the identify candidate function.

FIG. 11 is a flow diagram of a score candidate function.

FIG. 12 illustrates a sample web page for entry of advertising parameters for the develop advertising plan sub-component.

FIG. 13 illustrates sample tables of the historical data base. These tables represent the results of processing raw historical data.

FIG. 14 is a flow diagram of example implementation of a function of the develop advertising plan sub-component.

### DETAILED DESCRIPTION

A method and system for allocating display space to advertisers is provided. In one embodiment, the display space system allows advertisers to place bids for display space on web pages. The display space system works in conjunction with a server engine to add advertisements to web pages generated by the server engine. When the server engine generates a web page, it requests the display space system to provide an advertisement that is appropriate for the generated web page. In one embodiment, the display space system facilitates the advertising of commercial transactions (e.g., auctions) on web pages supporting the retail sale of items (e.g., books).

The display space system identifies the advertisement that is to be placed on a web page based on advertising plans specified by advertisers. An advertising plan may specify the identification of a web page or types of web pages, the type of advertisement (e.g., link or banner advertisement) to be placed on that web page, the time period during which the advertisement can be placed, and a bid amount. The bid amount is the amount that the advertiser is willing to pay to place the advertisement on a web page specified by the advertising plan. When the display space system is to provide an advertisement for a web page, a scheduling component of the display space system reviews the advertising plans to identify an advertisement to place on a web page. The scheduling component may select the advertising plan with the highest bid amount whose advertisement can be placed on that web page.

To assist advertisers, the display space system may provide help in developing an advertising plan for a transaction. The display space system may suggest the web pages and the bid amounts that the advertiser should use to advertise the transaction. In one embodiment, a develop advertising plan component of the display space system inputs advertising parameters and analyzes historical advertising data to develop an advertising plan that is appropriate for the advertising parameters. The advertising parameters may include the identification of the transaction to be advertised, the category of the item that is the subject of the transaction, and an advertising budget. The historical advertising data may include an indication of the effectiveness of advertising each category of items on each web page and an indication of the bid amounts used to place advertisements on each web page. The develop advertising plan component may use a constraint-based analysis to identify the web pages on which the transaction should be advertised and the amounts that should be bid for each web page. In one embodiment, the display space system can automatically supply an advertising plan to the scheduling component. In this way, the process of bidding on display space can be automatically performed based only on the advertising parameters.

The advertising plan may describe the types of users to whom the advertisement is to be displayed, the time period during which the advertisement is to be displayed, and the types of web pages on which the transaction is to be advertised. The types of users may be specified by their demographics and their purchasing history. For example, an advertiser may only want an advertisement for a kayak cover to be presented to users who are known to be between 18 and 30 years old. The time of day or the time of year when a web page is accessed may have an impact on whether an advertiser wants their advertisement included on that web page. For example, an advertiser may want an advertisement for a kayak cover to be included on web pages only during the spring or summer months. Advertisers also may only want their advertisements displayed on certain types of web pages. For example, an advertiser may want an advertisement for a kayak cover to be included on web pages for related products (e.g., kayaks) or on web pages for competing products (e.g., another kayak cover). By allowing advertisers to specify a detailed advertising plan, users are likely to be presented with advertisements that are appropriate to the subject matter of the web page that is being accessed (at least from the point of view of advertisers).

The display space system may allow advertisers to purchase display space at a fixed price (i.e., a fixed-price model) as an alternative to purchasing display space by placing the highest bid at an auction for the display space (i.e., an auction model). The display space system may also support a combination of selling display space at a fixed-price or at an auction. The display space system may base the pricing (fixed-price or bid amount) of display space on a per access basis or on a fixed price per time period basis. Generally, the number of accesses per web page cannot be determined in advance. Thus, an advertiser who wants to include their advertisement on each access to a web page during a certain time period cannot tell in advance precisely how many accesses will occur during that time period. When using a per access pricing strategy, an advertiser would pay a certain amount each time their advertisement is included on a web page. With such a pricing strategy, the advertisers would be charged based on the actual number of accesses. When using a fixed price per time period, an advertiser would pay a certain amount for display space on each web page (or certain percentage of web pages) during a specific time period. With such a pricing strategy, the advertiser would be charged a fixed fee regardless of the number of web pages accessed during that time interval. In the following, the display space system is described as using pricing based on a per access basis. One skilled in the art, however, will appreciate that display space system could use various alternate pricing schemes or combinations of pricing schemes.

When using a fixed-price model, rather than an auction model, the display space system assigns a fixed-price for the display space of each web page. An advertiser can purchase the display space in advance at the fixed price. The advertiser may specify an advertising plan, and the display system may provide the price per access for the advertisement. For example, the advertiser of a kayak cover may specify an advertising plan that specifies to display the advertisement on detailed web pages within a browse category of “kayaks,” that specifies to display the advertisement to users are 18-30 years old, and that specifies to display the advertisement during evening hours for a given month. The display space system may then respond that such display space can be purchased for a certain price per access. The display space system may also provide an estimate of the number of eligible web page accesses that will be made within the advertising time period based on historical access patterns. An eligible web page access is a web page access that satisfies the specifications of the advertising plan. The display space system may use various technique for establishing a per access price. For example, the display space system may have a fixed price for each access. With such a fixed price per access technique, an advertiser whose advertising plan that includes a very popular web page may pay a higher overall price per access than those advertisers whose advertising plans include less popular web pages. Also, the display space system may charge more per access when the advertising plan specifies a very specific web page or other very specific criteria. For example, an advertiser who wants to purchase display space on web pages for a certain type and model of kayak may pay more per access for this very targeted advertising than an advertiser who wants to purchase display space on any kayak-related web page. In one embodiment, the display space system may delay the assigning of a price to the access of a web page until after an advertiser signs up to purchase the display space. For example, if historical data shows that a certain web page is particularly effective or ineffective advertising medium at the time it is accessed, then the advertising price can be set accordingly at the time of access.

A display space system that uses a fixed-price model may set prices that are either too high or too low as compared to what an advertiser is willing to pay. If prices are too high, then display space may go unsold because advertisers believe that placing the advertisement at that price is not cost-effective. If the prices are too low, then the display space is sold at a lower price than advertisers are willing to pay. In either case, the owner of the display space loses revenue. In one embodiment, the display space system auctions off display space using an auction model. The display space system may auction off display space in a manner similar to conventional auctions of products or services. For example, the display space system may specify a certain type of display space and ask for bids from advertisers. The advertiser who places the highest per access bid wins the auction and their advertisements are included in the display space. A difficulty with such an auction approach is that the type of display space that is auctioned may not correspond to the needs of any advertiser. For example, an auction for display space on each web page in a certain category over a week time period will not meet the needs of an advertiser who wants to target their advertising to 18-30 year olds or an advertiser who wants to advertise only on web pages in certain sub-categories. Another difficulty is the overhead that may result in identifying categories auctionable display space and in coordinating the auctions.

To overcome these difficulties, the display space system allows each advertiser to specify via an advertising plan the display space for which the advertiser wants to bid. For example, as described above, one advertiser may want to place a bid on display space on any web page in a certain category when accessed by an 18-30 year old and another advertiser may want to place a bid on display space on every web page (or a certain percentage of web pages) within a certain sub-category. When a web page access meets the eligibility of multiple advertising plans, then the display space system may select the advertising plan with the highest bid amount. Such a strategy of selecting the highest bid amount may, however, not maximize the overall advertising revenue. For example, the time period of one advertising plan may be nearing its end, and not quite all of the requested number of web page access have been satisfied. In contrast, the time period of another advertising plan may be near its beginning and almost all the requested number of web page accesses may have been satisfied. If the display system awards display space to the advertising plan that is near the beginning of its time period because its bid is slightly higher than the bid of the advertising plan that is near the end of its time period, then the overall revenue may not be maximized. In particular, if the time period for the losing advertising plan expires without all the requested number of web page accesses being satisfied, then it would have increased the overall revenue if that display space had been awarded to the losing advertising plan (assuming that all the requested number for the winning advertising plan would still be satisfied). To assist in selecting an advertising plan, the display system may dynamically normalize bid amounts so that when a web page is accessed the display space can be allocated to the advertiser with-the highest normalized bid amount. The display system may normalize the bid amount using various factors, such as actual bid amount and the likelihood that the advertiser will be provided with display space on the requested number of web page accesses. The highest normalized bid is the bid that is anticipated to lead to the maximum overall revenue.

The display space system may use advertising points rather than an established currency for selling space. Potential advertisers may be allocated advertising points based on various types of activities, such as participating in various commercial transactions associated with a web site. For example, if the web site supports auctions, then a user who lists an item to be auctioned may be awarded a number of advertising points based on the minimum bid amount specified by the user. The user who lists the item may then use the advertising points to place advertisements for the auction. The display space system may allow the user to place a bid for display space or may allow the user purchase display space at a fixed-price using the advertising points. When the user has placed a successful bid or when the user purchases display space at a fixed price, the display space system reduces the number of advertising points allocated to that user. The display space system may allow users to accumulate advertising points based on other activity. For example, the display space system may allocate points to users who purchase items at a fixed price or at an auction or to owners of web sites who provide web pages with links to other web sites. The display space system may also allow users to trade their advertising points or to purchase additional advertising points. The display space system may also auction off advertising points that are paid for with an established currency.

The display space system may also allocate display space slots for different types of advertisements. For example, if a detailed web page may have display space or slots for three advertisements, the display space system may allocate two of the slots for advertisements by users of the web site and may allocate the other slot for owners of other web sites who provide click through to this web site. In this example, the users would bid against each other for the two allocated slots, and the owners of other web sites would bid only against each other for the other slot. The allocation of slots ensures that a certain class of advertisers will be guaranteed a certain number of slots. Therefore, certain classes of advertisers may only bid against other members in that class for display space.

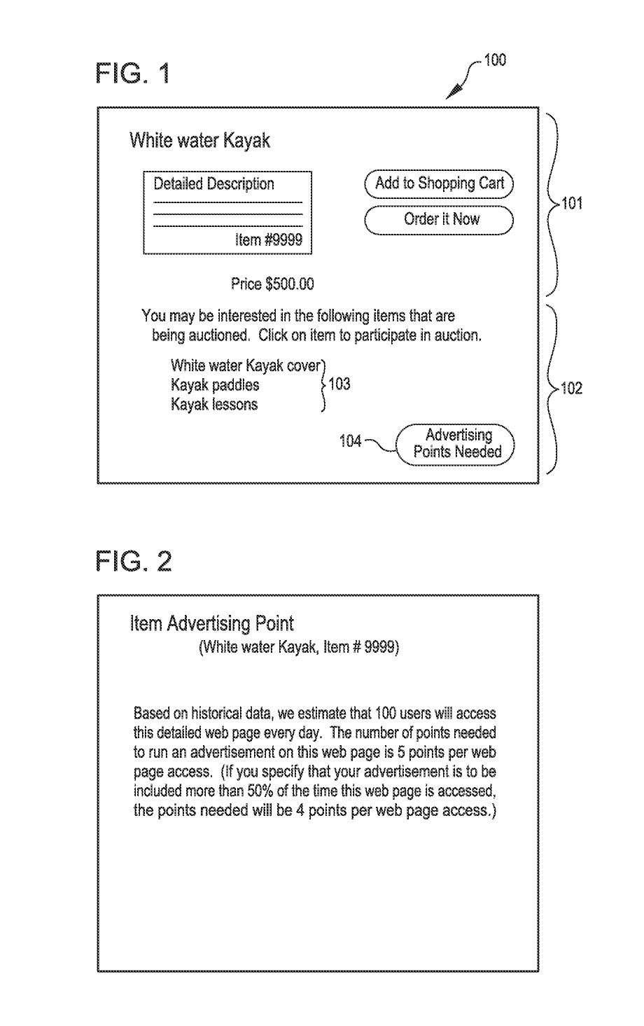

FIG. 1 illustrates a detailed web page that includes advertisements. The web page 100 includes a retail sale area 101 and an advertisement area 102. The retail sale area includes a description of the item being sold (e.g., a kayak), an add-to-shopping-cart button, an order-it-now button, and a purchase price. The advertisement area includes advertisements for commercial transactions related to various items. The advertisements 103 include advertisements for a kayak cover, for kayak paddles, and for kayak lessons, which are referred to as “link” advertisements. When a user selects a link advertisement, a web page related to the advertised commercial transaction is displayed. For example, if the advertisement for the kayak cover is for an auction, then the selecting of that link advertisement will result in display of a web page for placing a bid on the kayak cover. The advertisement area may also include an advertising-points-needed button 104 when the display space system uses a fixed-price model for selling display space. When a user selects the advertising-points-needed button, the display space system displays a web page indicating the number of advertising points needed to display an advertisement on this web page. If the auction model is used, then the advertisement area may have a button that links to a web page for submitting an advertising plan to bid for display space on this web page. FIG. 2 illustrates a web page that indicates the number of advertising points needed to purchase display space on the detailed web page of FIG. 1. This web page provides advertising point information for a detailed web page associated with the kayak. The advertising point information includes an estimate of the number of times the detailed web page will be accessed and the number of points needed to place an advertisement on this web page. In this example, the cost to advertise is five points per web page access. The advertising point information also indicates that the advertiser will receive a discount if the advertiser purchases display space on more than 50 percent of the web page accesses.

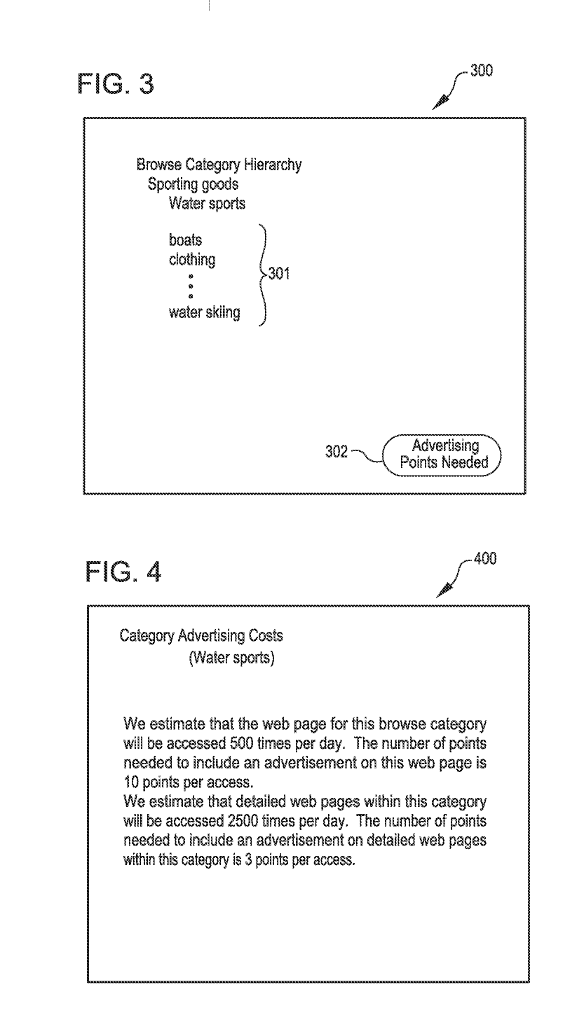

FIG. 3 illustrates the selecting of a browse category for obtaining advertising point information in a fixed-price model. The web page 300 includes a browse category hierarchy 301. In this example, the user has selected the “sporting goods” category and then selected the “watersports” sub-category. The “watersports” category includes the “boats,” “clothing,” and so on sub-categories. The display space system allows an advertiser to purchase display space on a web page associated with a certain browse category. As users browse through the browse category hierarchy when looking for detailed web pages, the display space system identifies advertisements to be included on the web pages generated as part of the browse category hierarchy or on detailed web pages within that category. An advertiser may select the advertising-points-needed button 302 to obtain advertising point information related to advertising on the web pages within the browse category. With the auction model, the web page may include a button for submitting an advertising plan for display space on web pages in the selected category. FIG. 4 illustrates a web page that includes advertising point information for a browse category. The web page 400 indicates the points needed to advertise within the “watersports” category. In one embodiment, the display space system allows an advertising plan to specify display space associated with the web page that displays the sub-categories of a browse category, with each sub-category-web page of that browse category, or with the detailed web pages for items within that browse category. The web page indicates that the display space system estimates that the web page for the “watersports” category will be accessed 500 times per day, and the web page indicates that the cost is 10 advertising points per access. The web page also indicates that the display space system estimates that detailed web pages within the “watersports” category will be accessed 2,500 times per day and that the cost is three advertising points per web page access. The display space system may generate these estimates based on an average of number of accesses over a certain time period.

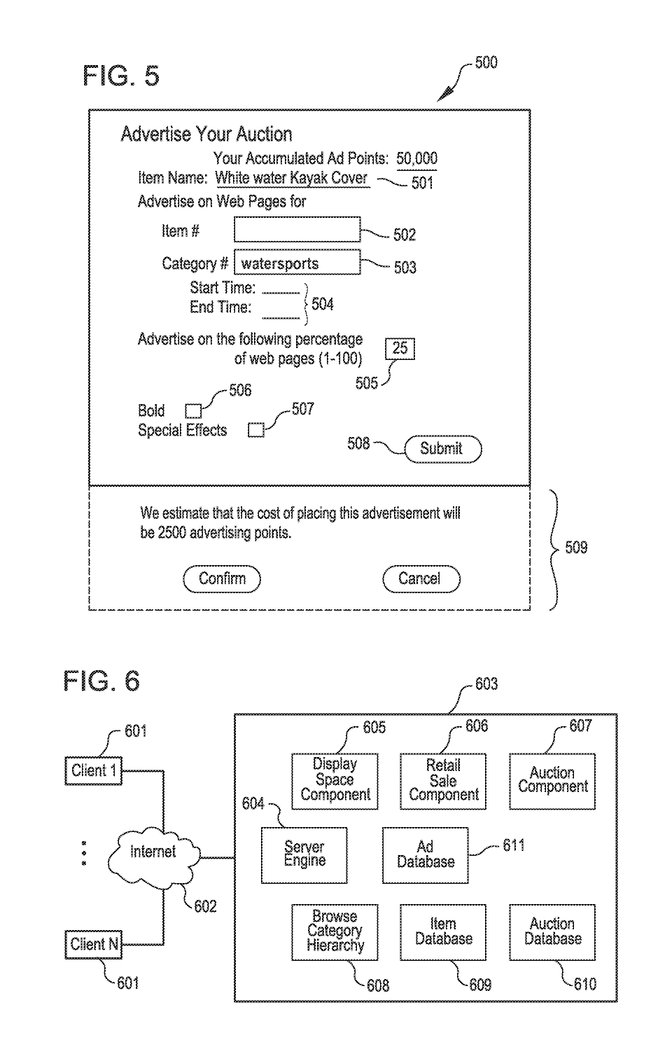

FIG. 5 illustrates a web page for submitting an advertising plan for purchasing display space using the fixed-price model. The web page 500 allows the user to specify what is to be advertised and where and when to place the advertisements. The display space system may provide this web page after a user lists an item to be auctioned. In this example, the advertiser has listed a kayak cover as indicated by the kayak cover title 501. Alternatively, the advertiser may input a link and title for the web page to be advertised. The web page includes an item number field 502, a category name field 503, a start and end time field 504, a percentage of accesses field 505, a bold field 506, and a special effects field 507. The web page also includes a submit button 508. An advertiser can specify to advertise either on detailed web pages for an item as indicated by the item number or on web pages associated with a browse category as indicated by the category name. The item number field and the category name field may provide access to various web pages for selecting an item number or browsing through the browse category hierarchy. In one embodiment, the web page may allow user to specify to advertise on detailed web pages or sub-category web pages of the indicated browse category. The advertiser can specify the start and end time for running the advertisements. The advertiser may also specify the percentage of the total web page accesses on which the advertisement is to be included. The web page also allows the user to specify certain special effects that may be used when displaying the advertisement. After the advertiser has entered the advertising plan, the advertiser selects the submit button. In response, the display space system displays the confirmation area 509. The confirmation area indicates that the estimated cost of placing the advertisement is 2,500 advertising points. The advertiser selects the confirm button to place the advertisement or selects the cancel button to cancel placement of the advertisement. The display space system may also indicate the cost per access to place the advertisement.

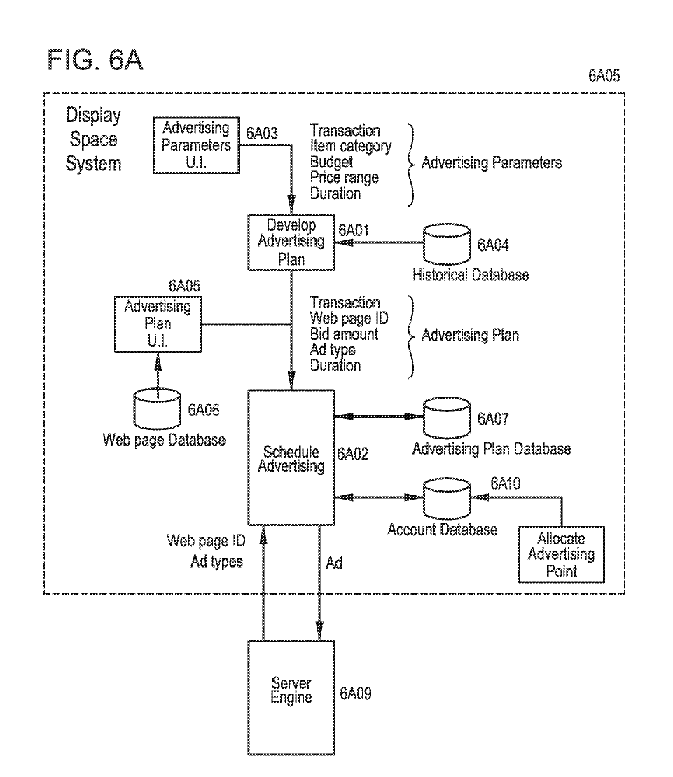

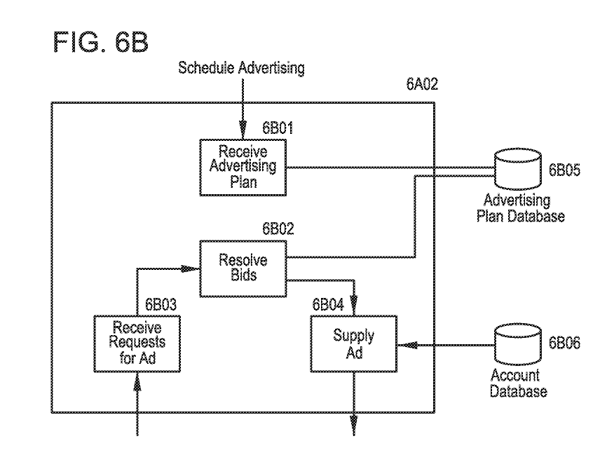

FIG. 6 is a block diagram illustrating the components of the display space system in one embodiment. The client computers 601 and server computer 603 are interconnected via the Internet 602. The computers may include a central processing unit, memory, input devices (e.g., keyboard and pointing device), output devices (e.g., display devices), and storage devices (e.g., a disk drive). The memory and the storage devices are computer-readable media which may contain computer instructions that implement the display space system. The client computers may use a browser to access various web pages via the Internet. The server computer implements the display space system. One skilled in the art will appreciate that the display space system may be used to allocate display space in non-Internet environments. The server computer includes a server engine 604, a display space component 605, retail sale component 606, and an auction component 607. The display space system also includes a browse category hierarchy 608, an item database 609, an auction database 610, and an advertisement database 611. The server engine receives requests for resources (e.g., web pages) via the Internet and coordinates the generation and transmission of the resources. The retail sale component coordinates commercial transactions for purchasing items described in the item database at a fixed-price. The auction component coordinates the auctioning of items specified in the auction database. The display space component controls the allocating of advertising points, the submitting of advertising plans, and the selecting of advertisements for web pages. The display space component stores advertising-related information in the advertising database. The browse category hierarchy contains the hierarchy for browsing through and locating items within the hierarchy. The browse category hierarchy may be used by the fixed-price sale component, the auction component, and the display space component.

FIG. 6A is a block diagram of the components of the display space system in one embodiment. In this embodiment, the display space system inputs advertising parameters and develops an advertising plan based on the advertising parameters. The display space system schedules advertisements based on various advertising plans that have been submitted. The display space system includes a develop advertising plan 6A01 sub-component and a schedule advertising 6A02 sub-component. The develop advertising plan sub-component inputs advertising parameters, such as the identification of the commercial transaction to be advertised, a category for the item that is the subject of the commercial transaction, a budget for the advertising, the price range associated with the commercial transaction, and the duration of the advertising. The advertising parameters may vary based on the types of transactions to be advertised and the sophistication of the develop advertising plan sub-component. For example, if auction-related transactions are being advertised, then the duration and category can be automatically derived from an auction-related database. Also, additional advertising parameters may be included, such as the preferred demographics of the users to whom the advertisement is displayed. The entry of the advertising parameters may be controlled by the advertising parameters user interface 6A03. The develop advertising plan sub-component outputs an advertising plan that may include the identification of the commercial transaction to be advertised, the identification of a web page on which the advertisement should be placed, the amount that should be bid for the display space, the type of advertisement that should be placed, and the duration of the advertising. The develop advertising plan sub-component may use various constraint-based algorithms to develop the advertising plan. One such constraint-based algorithm uses a constraint hierarchy as described in Bjorn, Freeman-Benson, and Wilson, “Constraint Hierarchies,” LISP and Symbolic Computation: An International Journal, 5, 223-270, 1992, which is hereby incorporated by reference. These algorithms may analyze historical data stored in a historical database 6A04. The historical database may contain raw historical data or processed historical data. The raw historical data may include information describing the advertisements that have been displayed on each web page, the click-throughs to the advertised commercial transactions, and the resulting participation in the commercial transactions. The processed historical data may include information describing the categories of items that have been advertised on each web page and an indication of the resulting effectiveness of that advertisement. The schedule advertising sub-component may input advertising plans either from the develop advertising plan sub-component or from an advertising plan user interface 6A05. The advertising plan user interface is a user interface through which a user can specify an advertising plan. The advertising plan user interface may access a web page database 6A06 to assist the advertiser in developing the advertising plan. The schedule advertising sub-component inputs advertising plans, develops an advertising schedule either in real-time or in batch mode, and provides the advertisements to be included on various web pages. The schedule advertising sub-component stores the advertising plans in advertising database 6A07. When an advertisement is placed, the schedule advertising sub-component adjusts the advertiser's account in the account database 6A07. The display space system also includes an allocate advertising point sub-component 6A08 that receives various indications of commercial transactions and allocates advertising points based on those commercial transactions. For example, the allocate advertising sub-component may allocate advertising points to a user when they list an item on auction.

FIG. 6B is a block diagram illustrating the sub-components of the schedule advertising component. The schedule advertising component includes a receive advertising plan sub-component 6B01, a resolve bids sub-component 6B02, a receive request for advertisement sub-component 6B03, and a supply advertisement sub-component 6B04. The received advertising plan sub-component receives advertising plans and stores them in the advertising plan database. The resolve bids sub-component receives requests for advertisements and identifies the advertising plan that should be allocated to the display space. The receive request for advertisements sub-component receives the identification of a web page and the type and number of advertisements that are to be included on a web page. The supply advertisement component receives an indication of the advertising plan whose advertisements are to be included on the web page, updates the account database, and provides the advertisements to the server engine.

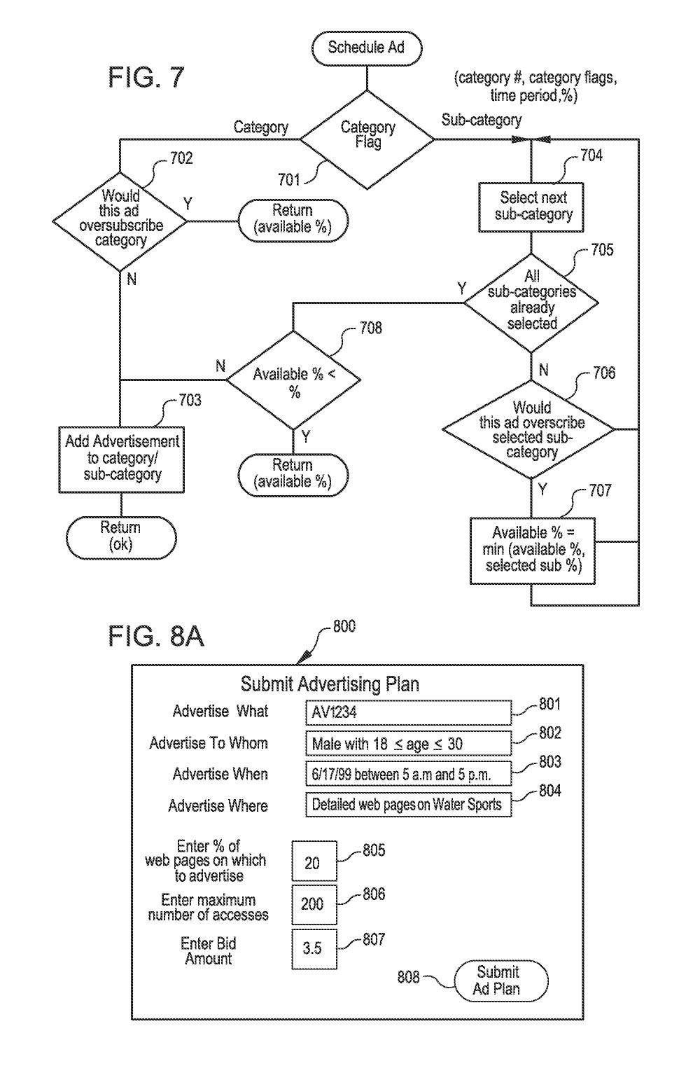

FIG. 7 is a flow diagram of an example function to schedule advertisements in advance using the fixed-price model. This function adds the advertising plan to the schedule by determining if the advertising plan can be satisfied. The schedule may indicate which advertisements are to be placed on which web pages. This function is a sub-component of the display space component. This function is passed an advertising plan, which includes the name of the category, a category flag, a time period, and a percentage. The category flag indicates whether the advertiser wants to advertise on the category web page, on each sub-category web page of that category, or on each detailed web page within the category. For example, if the category is “watersports,” then the sub-category web pages may be for “boats,” “clothing,” and so on. The function determines whether the advertising plan can be satisfied and, if so, updates the schedule. In step 701, if the category flag indicates to advertise only on the category web page, then the function continues at step 702, else the function continues at step 704. (The process of determining whether the display space for the detailed web pages are available is not illustrated in this flow diagram.) In step 702, the function determines whether the placement of this advertisement would oversubscribe the advertisements of the category. For example, if the advertiser requested that the advertisement be placed on 50 percent of the web page accesses and 75 percent of the web page accesses within that category have already been allocated to advertisements, then the advertisements for this category would be oversubscribed. If the placement of this advertisement would oversubscribe the accesses, then the function returns an indication of the percentage of the display space that is available, else the function continues at step 703. In step 703, the function stores information describing the advertisement in the advertisement database and then returns. In steps 704-707, the function loops determining whether any display space for sub-categories would be oversubscribed by placing the advertisement. If so, the function returns an indication of the smallest percentage of available display space within a sub-category. In step 704, the function selects the next sub-category. In step 705, if all the sub-categories have already been selected, then the function continues at step 708, else the function continues at step 706. In step 706, if the placing of this advertisement would oversubscribe the selected sub-category, then the function continues at step 707, else the function loops to step 704 to select the next sub-category. In step 707, the function sets the minimum percentage of display space within a sub-category to the minimum of the previously set minimum percentage and the available percentage for the selected sub-category. The function initializes the minimum percentage to the requested percentage. The function then loops to step 704 to select the next sub-category. In step 708, if the placing of this advertisement would oversubscribe the display space for a sub-category, then the function returns an indication of the minimum percentage of display space that is available, else the function adds the advertising plan to the advertisement database in step 703 and returns.

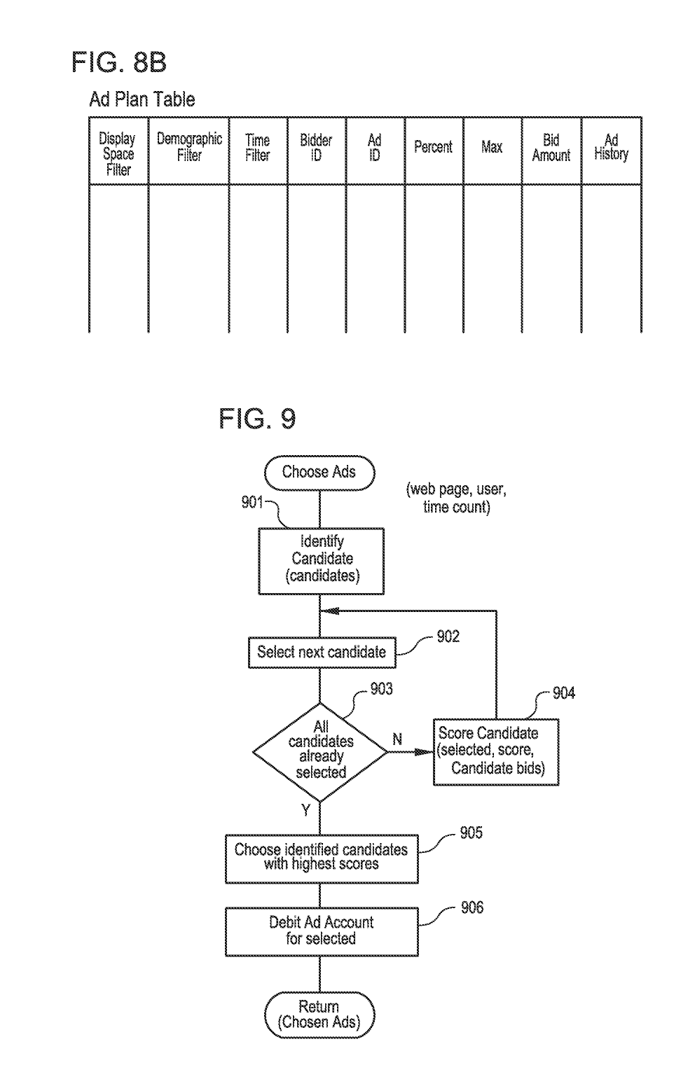

FIG. 8A illustrates a web page for submitting an advertising plan in one embodiment. The web page 800 includes fields 801-804 so that the advertiser may indicate what to advertise, to whom to advertise, when to advertise, and where to advertise. The web page also includes a percentage field 805 for indicating what percentage of the web page accesses should include the advertisement and a maximum number of accesses field 806 for indicating the maximum number of accesses for this advertising plan. The amount field 807 indicates the number of advertising points that the advertiser wants to bid for the specified display space. When the advertiser selects the submit-ad-plan button 808, the display space system stores the advertising plan into the advertising plan database. The advertiser uses the “advertise what” field to specify what is to be advertised. For example, the advertiser may enter the URL of a web page, the identifier of an auction, or an identifier of another type of commercial transaction. The advertiser uses the “advertise to whom” field to indicate the criteria for selection of users who are to be presented with the advertisement. For example, the advertiser may want the advertisement to be seen only by males who are 18-30 years old. The specification in the “advertise to whom” field made be entered in a query-type language. This specification may refer to the purchasing history of the users. For example, the specification may indicate to present the advertisement only to those who have purchased a certain type of item within the last month, who have not yet seen the advertisement, or who have not yet clicked through using the advertisement. An advertiser of a kayak cover may also indicate that the advertisement should only be presented to those who have purchased kayak-related equipment within the last month. An advertiser uses the “advertise when” field to specify the dates and time periods when the advertisement is to be presented. For example, the time period may be on a certain day and within a certain time range. The advertiser uses the “advertise where” field to indicate the web pages on which the advertisement is to be included.

FIG. 8B illustrates an advertisement plan table within the advertising plan database. The advertising plan table contains an entry for each advertising plan. The advertising plan table in one embodiment contains a display space filter, a demographic filter, a time filter, a bidder ID, an advertisement ID, a percentage field, a maximum web page access field, a bid amount, and an advertisement history field. The display space system uses the display space filter, the demographic filter, and a time filter to determine whether a web page that is being generated meets the eligibility of the advertising plan. If the web page meets the eligibility, then the display space system considers the advertising plan to be a candidate. The display space system then selects a candidate advertising plan to include on the web page. The display space system may use various criteria when selecting a candidate to include on the web page. For example, the display space system may select the candidate with the highest bid amount. Alternatively, the display space system may use an algorithm to identify which of the candidates should be selected to maximize the overall number of advertising points that are consumed (e.g., total revenue). The display space system may normalize the bid amounts (or score the bids) and then select the advertising plan with the highest normalized bid (or score). The advertisement history field track the number of times the advertisement has already been presented to users and information as to when and where advertisement was displayed. It may also track the total number of accesses to web pages on which the advertisement was eligible to be placed. The display space system may use this total number to track whether an advertiser is receiving the requested percentage of placements.

FIG. 9 is a flow diagram of an example implementation of the resolve bids function of the display space component. This function chooses the advertising plans whose advertisement should be included on a web page being generated. This function is passed an indication of the web page, of the user who is accessing the web page, of the time of access, and of the count of the number of advertisements that can be placed on that web page. In step 901, the function identifies the candidate advertising plans for this web page by invoking the identify candidates function. In steps 902-905, the function loops selecting each candidate and scoring the benefit of placing the advertisement of the selected candidate on this web page. In step 902, the function selects the next candidate. In step 903, if all the candidates have already been selected, then the function continues at step 905, else the function continues at step 904. In step 904, the function scores the selected candidate by invoking the score candidate function. The function then loops to step 902 to select the next candidate. In step 905, after all the candidates have been scored, the function chooses the identified candidates with the highest scores. In step 906, the function debits the advertisement account for the advertisers of the chosen candidates. The advertisement account indicates the total number of advertising points allocated to the advertiser. The function then returns an indication of the advertisements of the chosen candidates.

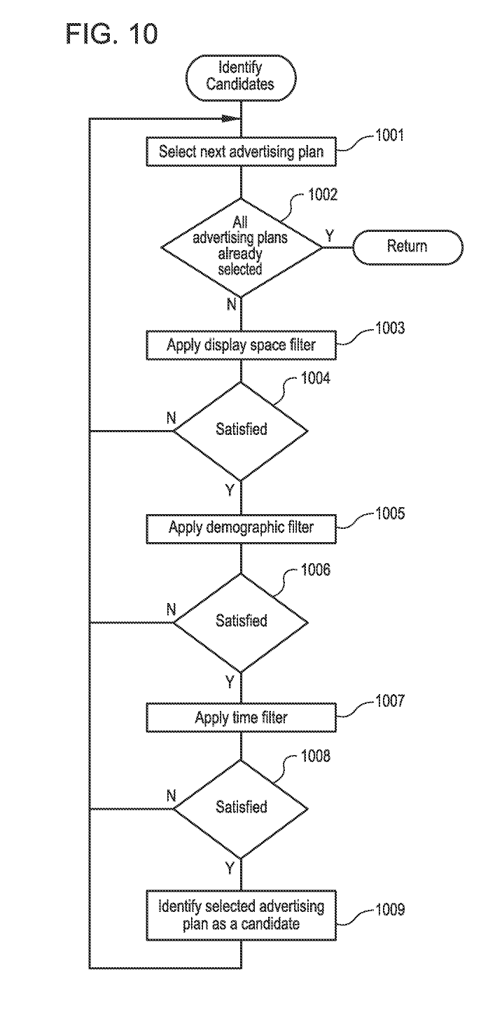

FIG. 10 is a flow diagram of an example implementation of the identify candidate function. This function identifies those advertising plans (i.e., candidates) whose advertisements are eligible to be on the web page being generated. In steps 1001-1009, the function loops selecting each advertising plan in the advertising plan table and identifying whether the advertisement for the selected advertising plan is appropriate for the web page being generated, for the user who is accessing the web page, and for the current time. One skilled in the art will appreciate that the advertising plan table may use various indexing techniques to minimize the number of advertising plans that are evaluated when selecting candidates. For example, the advertising plan table may be indexed by the age of the users as indicated by the demographic filter. In this way, if the user to whom the web page is to be displayed is 25 years old, the function need only evaluate advertising plans whose demographic filter includes a 25 year old. In step 1001, the function selects the next advertising plan. In step 1002, if all the advertising plans have already been selected, the function returns, else the function continues at step 1003. In step 1003, the function applies the display space filter of the selected advertising plan. The display space filter specifies the type of web page on which the advertisement may be included. For example, the display space filter may indicate that the advertisement should be included on web pages for auctions that relate to kayaks. In step 1004, if the display space filter is satisfied, the function continues at step 1005, else the function loops to step 1001 to select next advertising plan. In step 1005, the function applies the demographic filter to the user. The demographic filter may indicate that the advertisement should be displayed to 18-30 year olds. In step 1006, if the demographic filter is satisfied, then the function continues at step 1007, else the function loops to step 1001 to select the next advertising plan. In step 1007, the function applies the time filter to the current time. In step 1008, if the time filter is satisfied, then the function continues at step 1009, else the function loops to step 1001 to select the next advertising plan. In step 1009, the function identifies the selected advertising plan as a candidate and then loops to step 1001 to select the next candidate.

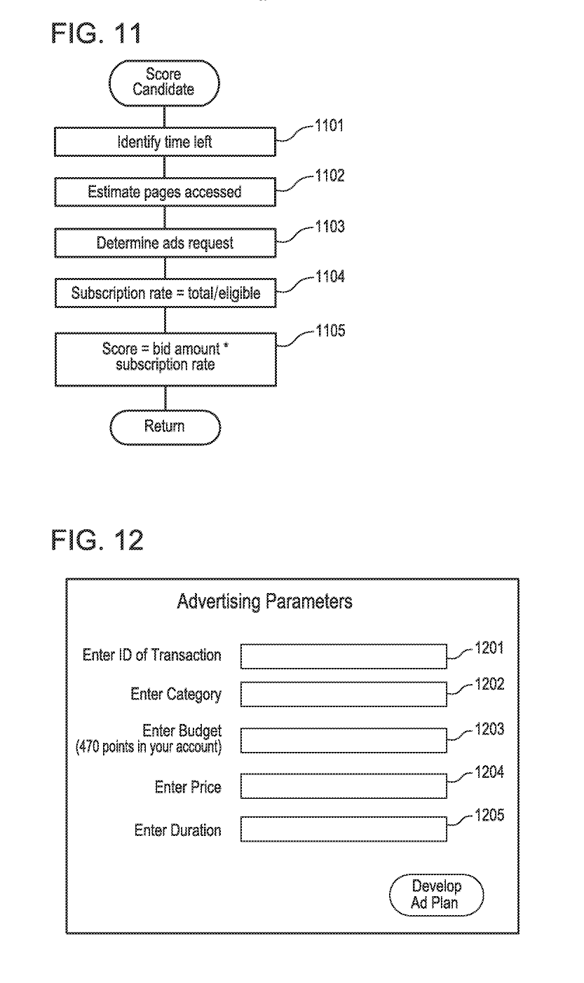

FIG. 11 is a flow diagram of a score candidate function. This function is passed the candidates and an indication of which one is selected and returns a score for the selected candidate. In this example implementation, the function scores the candidate based on the estimated number of eligible accesses of web pages on which the advertisement of the selected candidate can be displayed. The function also estimates the number of those web page accesses for which bids have placed. The ratio of the number of those web page accesses for which bids have been placed to the number of eligible web page accesses is the subscription rate. A subscription rate of 1 indicates that all the bids for the web pages of the eligible accesses can be accepted, and a subscription rate of 2 indicates that only half of the bids can be accepted. The function generates the score by multiplying the bid amount by the subscription rate. One skilled in the art will appreciate that many different algorithms can be used to score advertising plans or normalize bid amounts. In step 1101, the function identifies the time left for the passed candidate. For example, the time filter may indicate that the advertisement may be placed on web pages during a total of 10 more hours. In step 1102, the function estimates the number of accesses that will be made in the time left for web pages on which the advertisement for the selected candidate may be placed. The function may estimate the number of accesses based on historical access patterns. In step 1103, the function estimates a total number of web page accesses for which bids have been placed within that time left by the candidates. In step 1104, the function generates a subscription rate by dividing the total number of web page accesses by the eligible number. In step 1105, the function generates a score by multiplying the bid amount of the passed candidate by the subscription rate. The function then returns the score.

FIG. 12 illustrates a sample web page for entry of advertising parameters for the develop advertising plan sub-component. Web page 1200 includes a fields 1201-1205 through which a user can input the identification of a transaction to be advertised, the category of the item that is the subject of the transaction, an advertising budget, the price range of the item, and the duration of the transaction. The advertiser then selects the develop advertising plan button 1206 to start the development of an advertising plan by the display space system. The advertising plan may then be displayed so that the advertiser can modify the plan before submitting it.

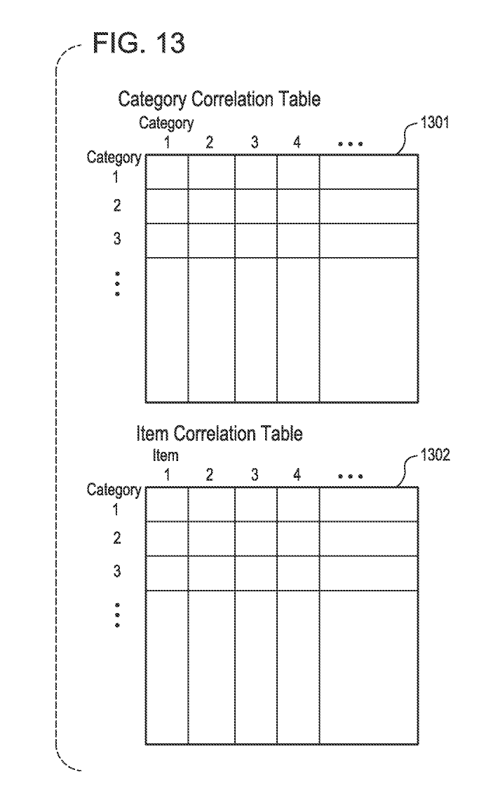

FIG. 13 illustrates sample tables of the historical data base. These tables represent the results of processing raw historical data. Table 1301 is a category correlation table. This table provides a correlation between various browse categories. The correlation indicates the likelihood that a viewer of a particular browse category web page is interested items in each of the other categories. A correlation of one indicates that all viewers of a browse category are interested in the items of the other browse category. The developed advertising plan may generate the category correlation table based on historical access patterns of the viewers. One skilled in the art will appreciate the correlation values can be generated using standard correlation techniques. The item correlation table 1302 provides the correlation between each browse category and each item.

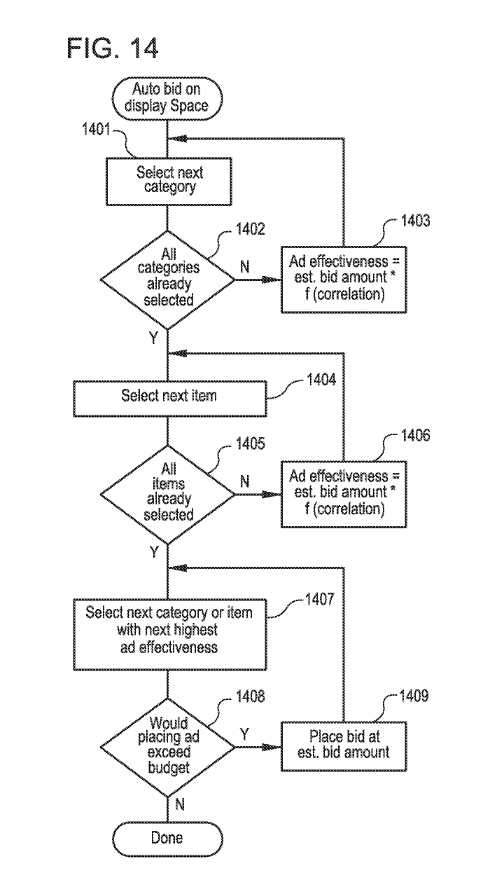

FIG. 14 is a flow diagram of example implementation of a function of the develop advertising plan sub-component. This function calculates the advertisement effectiveness of placing advertisements on category and detailed item web pages. The function selects categories and detailed web pages with the highest calculated advertising effectiveness. The function returns an indication of category and detailed web pages along with an estimated bid amount as part of an advertising plan. In steps 1401-1403, the function loops calculating the advertising effectiveness for each category. In step 1401, the function selects the next category. In step 1402, if all categories have already been selected, then the function continues at step 1404, else the function continues at step 1403. In step 1403, the function calculates the advertising effectiveness of placing an advertisement on web pages for the selected category. The function then loops to step 1401 to select the next category. The advertising effectiveness may be the product of an estimated bid amount needed to win placement of the advertisement on web pages for the selected category times a function of the correlation. In steps 1404-1406, the function calculates the advertising effectiveness for each item. In step 1404, the function selects the next item starting with the first. In step 1405, if all the items have already been selected, then the function continues at step 1407, else the function continues at step 1406. In step 1406, the function calculates the advertising effectiveness of placing the advertisement on a web page for the selected item. The function then loops to step 1404 to select the next item. In steps 1407-1409, the function identifies a suggested bid amount for advertising on a category or detailed item web page with the next highest advertising effectiveness. In step 1407, the function selects the next category or item web page with the next highest advertising effectiveness. In step 1408, if placing a bid on the selected category or item would exceed the advertising budget, then the function is done, else the function continues at step 1409. In step 1409, the function suggests a bid amount and then loops to select the next category in step 1407.

From the foregoing, it will be appreciated that all of specific embodiments of the invention have been described here in the purposes of illustration, various modifications may be made without deviating from the spirit and scope of the invention. For example, under the auction model, the display space of the web pages can be allocated in advance rather than dynamically when the web page is being generated. The display space system may decide once a day which bids are to be allocated display space. Accordingly, the invention is not limited except by the following claims.

1-30. (canceled)

31. A computer-implemented method, comprising:
receiving listing information identifying an item offered for sale in an online auction, the item offered for sale on behalf of a user;
identifying, by one or more computer systems configured with executable instructions, a minimum bid amount assigned to the item based on the listing information;
determining a number of advertising points based on the minimum bid amount;
allocating the number of advertising points to the user as a result of participation in the online auction;
maintaining a record of a total number of advertising points allocated to the user utilizing an advertisement account associated with the user, the total number of advertising points at least including the allocated number of advertising points;
receiving, on behalf of the user, a request for allocation of advertising space in exchange for an amount of allocated advertising points;
providing the requested advertising space to the user; and
reducing the total number of advertising points maintained for the user by the amount of advertising points at least in response to providing the requested advertising space to the user.

32-33. (canceled)

34. The computer-implemented method of claim 31, wherein the minimum bid amount is received from the user and based on assignment by the user.

35. (canceled)

36. A system, comprising:
a memory that stores computer-executable instructions; and
a processor configured to access the memory, wherein the processor is configured to execute the computer-executable instructions to collectively at least:
maintain a record of a total number of advertising points associated with a user;
receive listing information identifying an item offered for sale in an online auction, the item offered for sale on behalf of the user;
identify, from the listing information, a minimum bid amount assigned to the item;
determine a number of advertising points to allocate based on the minimum bid amount;
increase the total number of advertising points based on the number of advertising points to allocate to the user;
receive, on behalf of the user, a request to acquire advertising space for an amount of advertising points; and
provide the requested advertising space in exchange for the amount of advertising points indicated in the request to acquire advertising space.

37-40. (canceled)

41. The computer-implemented system of claim 36, further comprising: reducing the total number of advertising points by the amount of advertising points indicated in the request to acquire advertising space at least in response to providing the requested advertising space.

42. The computer-implemented system of claim 36, wherein the request to acquire advertising space includes a bid amount.

43. The computer-implemented system of claim 42, wherein the bid amount specifies the amount of advertising points to be exchanged for the advertising space.

44. The computer-implemented system of claim 36, wherein the advertising space is configured to advertise for an auction.

45. One or more non-transitory computer-readable medium storing computer-executable instructions for managing advertising points that, when executed by one or more computer systems, configure the one or more computer systems to perform operations comprising:
maintaining a record of a total number of advertising points associated with a user;
obtaining listing information identifying an item offered for sale in an online auction;
identifying a minimum bid amount from the obtained listing information;
identifying, from the listing information, a minimum bid amount assigned to the item;
determining a number of advertising points based on the minimum bid amount;
allocating the number of advertising points based on the minimum bid amount;
increasing the total number of advertising points based on the number of advertising points allocated to the user;
receiving on behalf of the user a request to acquire advertising space for an amount of advertising points; and
reducing the total number of advertising points maintained for the user by an amount of advertising points at least in response to providing the requested advertising space to the user.

46-48. (canceled)

49. The one or more non-transitory computer-readable storage medium of claim 45, wherein the item offered for sale is a fixed amount of advertising points.

50. (canceled)
